(19) United States
(12) Patent Application Publication
(10) Pub. No.: US 2017/0040850 A1
(43) Pub. Date: Feb. 9, 2017

(54) LAMINATED IRON CORE, METHOD FOR MANUFACTURING LAMINATED IRON CORE, AND PUNCH FOR CAULKING FORMATION USED IN THE METHOD

(71) Applicant: MITSUI HIGH-TEC, INC., Kitakyushu-shi (JP)

(72) Inventor: Akihiro HASHIMOTO, Fukuoka (JP)

(73) Assignee: MITSUI HIGH-TEC, INC., Kitakyushu-shi (JP)

(21) Appl. No.: 15/227,141

(22) Filed: Aug. 3, 2016

(30) Foreign Application Priority Data
Aug. 7, 2015 (JP) 2015-157190

(51) Int. Cl. H02K 1/06; H02K 15/02; B21D 28/24; H01F 41/02

(52) U.S. Cl. CPC H02K 1/06; H01F 41/0233; H02K 15/02; B21D 28/24; H02K 2201/09

(57) ABSTRACT

A laminated iron core includes a plurality of iron core pieces laminated each other, each iron core piece having a thickness of 0.2 mm or less. Each of the plurality of iron core pieces includes a flat part, openings and a pair of caulking protrusions opposed and separated from each other in plan view, each caulking protrusion having one end continuing with the flat part and the other portion being separated from the flat part to be inclined in a lamination direction of the iron core pieces. The pair of caulking protrusions of each iron core piece are fitted into the openings formed in an adjacent one of the plurality of iron core pieces in the lamination direction to join the plurality of iron core pieces, and the other ends of the pair of caulking protrusions face toward each other or face in opposite directions.

### CROSS REFERENCE TO RELATED APPLICATION

This application is based upon and claims the benefit of priority of Japanese Patent Application No. 2015-157190 filed on Aug. 7, 2015, the contents of which are incorporated herein by reference in its entirety.

### BACKGROUND OF THE INVENTION

1. Field of the Invention

The present invention relates to a laminated iron core formed by laminating a plurality of iron core pieces blanked from a thin plate material with a thickness of 0.2 mm or less, a method for manufacturing the laminated iron core, and a punch for caulking formation used in the method for manufacturing the laminated iron core.

2. Description of the Related Art

A laminated iron core constructing an electric motor is manufactured by blanking an electromagnetic steel plate with a thin plate thickness in a predetermined shape and laminating a predetermined number of electromagnetic steel plates and interlocking the electromagnetic steel plates by caulking using, for example, a press line.

This known caulking is caulking (so-called flat caulking) with the electromagnetic steel plate half blanked, or caulking (so-called V caulking) separated from the electromagnetic steel plate to form an inclined surface.

In recent years, a laminated iron core using an electromagnetic steel plate with a thinner plate thickness has been increased in order to improve performance of the electric motor. As the plate thickness of the electromagnetic steel plate becomes thinner, the performance of the electric motor is improved, but in this case, it becomes difficult to control a press bottom dead center, and the flat caulking cannot be formed, with the result that the electromagnetic steel plates are generally interlocked by the V caulking (for example, see JP-A-2-264411 as Patent Literature 1).

However, it is difficult to form the V caulking in a thin plate material with a plate thickness of 0.2 mm or less.

This is because cracks occur in a bottom surface since in formation of the V caulking, the bottom surface is normally overhung and formed and an inclined surface is drawn.

Also, in the case of the V caulking, both the inclined surfaces are pressed in an iron core piece of a lower stage and the adjacent iron core pieces are interlocked, with the result that there is also a problem that the periphery in a region of formation of the V caulking is deformed.

Hence, it is contemplated to form a slit in the bottom surface of the V caulking in order to adjust an interlocking force (for example, see JP-A-2006-166500 as Patent Literature 2).

Patent literature 1: JP-A-2-264411

Patent Literature 2: JP-A-2006-166500

### SUMMARY OF THE INVENTION

However, for example, when the size of the slit is very small, it is difficult to form the slit. This phenomenon occurs particularly in the case of a small-size laminated iron core.

The present invention has been implemented in view of such circumstances, and a non-limited object of the present invention is to provide a laminated iron core capable of tight caulking lamination even using a thin plate material with a thickness of 0.2 mm or less, a method for manufacturing the laminated iron core, and a punch for caulking formation used in the method for manufacturing the laminated iron core.

A first aspect of the present invention provides a laminated iron core including: a plurality of iron core pieces laminated each other, each iron core piece having a thickness of 0.2 mm or less, wherein each of the plurality of iron core pieces includes a flat part, openings and a pair of caulking protrusions opposed and separated from each other in plan view, each caulking protrusion having one end continuing with the flat part and the other portion being separated from the flat part to be inclined, in a lamination direction of the iron core pieces, the pair of caulking protrusions of each iron core piece are fitted into the openings formed in an adjacent one of the plurality of iron core pieces in the lamination direction to join the plurality of iron core pieces, and the other ends of the pair of caulking protrusions face toward each other or face in opposite directions.

The openings of the iron core piece may be formed at an area of the pair of caulking protrusions due to separation of the other portion from the flat part.

The laminated iron core may further includes another iron core piece at least disposed at a lowermost layer of the laminated iron core and including caulking through holes into which the pair of caulking protrusions of adjacent one of the plurality of iron core pieces in the lamination direction are fitted.

A shape of the other end of the caulking protrusion may be a circularly arcuate shape in plan view.

A tip of the other end of the caulking protrusion may abut on an inner peripheral surface of the opening of the adjacent iron core piece.

The iron core piece may be formed in a U shape in plan view, and a width of the iron core piece in a formation position of the caulking protrusion may be in a range from 5 mm to 30 mm, both inclusive.

A second aspect of the present invention provides a method for manufacturing a laminated iron core by blanking a plurality of iron core pieces from a thin plate material with a thickness of 0.2 mum or less and laminating the iron core pieces thus blanked, the method including: punching the thin plate material to form a pair of caulking protrusions, each having one end continuing with the thin plate material and the other portion being separated from the thin plate material; blanking a contour of the iron core piece from the thin plate material; and fitting the pair of caulking protrusion of each iron core piece into openings of an adjacent one of the plurality of iron core pieces in a lamination direction of the iron core pieces to join the plurality of iron core pieces, wherein the pair of caulking protrusions are formed to be opposed and separate from each other in plan view, and the other ends of the pair of caulking protrusions face toward each other or face in opposite directions.

The openings of the iron core piece may be formed at an area of the pair of caulking protrusions due to separation of the other portion from the thin plate material.

The method for manufacturing the laminated iron core may further include forming another iron core piece at least disposed at a lowermost of the laminated iron ore and including caulking through holes into which the pair of caulking protrusions of adjacent one of the plurality of iron core pieces in the lamination direction are fitted.

A shape of the other end of the caulking protrusion may be a circularly arcuate shape in plan view.

A tip of the other end of the caulking protrusion may be abutted on an inner peripheral surface of the opening of the adjacent iron core piece.

The iron core piece may be formed in a U shape in plan view, and a width of the iron core piece in a formation position of the caulking protrusion may be in a range from 5 mm to 30 mm, both inclusive.

A third aspect of the present invention provides a punch for caulking formation, for punching a thin plate material with a thickness of 0.2 mm or less to form a pair of caulking protrusions, each having one end continuing with the thin plate material and the other portion being separated from the thin plate material to be inclined in a lamination direction in order to caulk and laminate a plurality of iron core pieces blanked from the thin plate material, the punch including: a pair of punch parts provided symmetrical the punch parts forming the pair of caulking protrusions to be opposed and separate from each other in plan view such that the other ends of the pair of caulking protrusions face toward each other or face in opposite directions.

In the laminated iron core, the method for manufacturing the laminated iron core and the punch for caulking formation used in the method for manufacturing the laminated iron core according to the aspects of the present invention, the caulking protrusions which are formed on each of the iron core pieces and join the plural iron core pieces are opposed separate in plan view and the paired caulking protrusions are formed such that the other ends of the paired caulking protrusions face toward each other or face in opposite directions, with the result that the plural laminated, iron core pieces can be tightly joined (interlocked) without inclination by a synergistic effect of the paired caulking protrusions.

Consequently, even using the thin plate material with the thickness of 0.2 mm or less, tight caulking lamination is enabled, with the result that the laminated iron ore with good magnetic characteristics can be provided.

Also, when the shape of the other end of the caulking protrusion is formed in the circularly arcuate shape in plan deformation or cracks in its tip can be inhibited, further prevented as compared with the case of being formed in a rectangular shape, with the result that the plural iron core pieces can be joined more surely.

Moreover, when the tip of the other end of the caulking protrusion is abutted on the inner peripheral surface of the opening of the adjacent iron core piece, the iron core piece can be inhibited from deviating in a radial direction, and the iron core pieces can be joined more tightly.

Further, when the iron core piece is formed in the U shape in plan view and the width of the iron core piece in the formation position of the caulking protrusion is in the range from 5 mm to 30 mm, the laminated iron core has a small size, with the result that an effect of the present invention becomes more remarkable.

### BRIEF DESCRIPTION OF THE DRAWINGS

In the accompanying drawings:

FIG. 1A is a plan view of a laminated iron core according to one embodiment of the present invention;

FIG. 1B is a sectional view taken on arrow IB-IB in FIG. 1A;

FIG. 2 is an explanatory diagram of a method for manufacturing the laminated iron core:

FIGS. 3A to 3E are partially sectional side views of laminated iron cores according to first to fifth modified examples, respectively;

FIG. 4 is a plan view of a laminated iron core according to a sixth modified example; and

FIG. 5 is an explanatory diagram of a punch for caulking formation used in the method for manufacturing the laminated iron core according to one embodiment of the present invention.

### DETAILED DESCRIPTION OF THE EXEMPLARY EMBODIMENTS

Subsequently, an embodiment embodying the present invention will be described with reference to the accompanying drawings, and the present invention be understood.

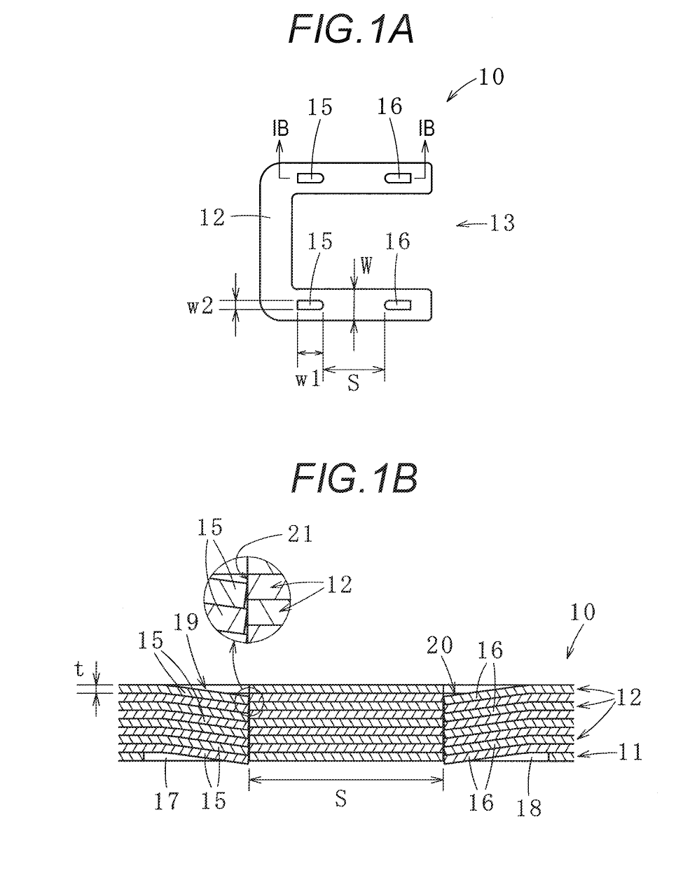

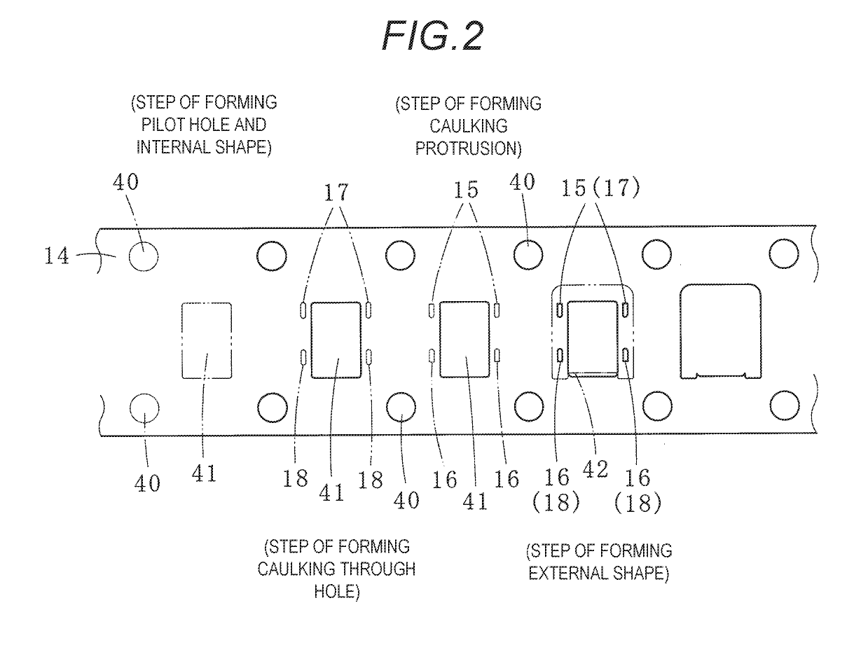

First, a laminated iron core 10 according to one embodiment of the present invention will be described with reference to FIGS. 1A, 1B and 2.

As shown in FIGS. 1A and 1B, the laminated iron core 10 is used in an electric motor, and is formed by laminating a plurality of iron core pieces 11, 12 with a recessed shape (U shape) in plan view. A shape of the iron core piece is not limited to this shape, and can be changed variously according to a kind of electric motor manufactured (for example, a size or a kind of laminated iron core, and the same applies hereinafter).

In use of this laminated iron core 10, for example, in plan view, the four laminated iron cores 10 are arranged in the center of each side of a virtual square and each of the laminated iron cores 10 is further arranged so that an opening portion 13 of each of the laminated iron cores 10 faces to a center position of the virtual square (the opening portions 13 of the two opposed laminated iron cores 10 face toward each other), but the use of the laminated iron core 10 is not limited to this arrangement.

As shown in FIG. 1A, the laminated iron core 10 (iron core pieces 11, 12) has a small size with a width W ranging from about 5 mm to 30 mm (both inclusive) in plan view, but can be changed variously according to a kind of electric motor manufactured.

The iron core pieces 11, 12 constructing this laminated iron core 10 are blanked and formed from a thin metal sheet (one example of a thin plate material) 14 made of, for example, an amorphous material or an electromagnetic steel plate with a thickness of 0.2 mm or less as shown in FIG. 2. In addition, each of the iron core pieces 11, 12 may be a piece blanked from one thin metal sheet, or a piece blanked from plural (for example, two, or three or more) stacked thin metal sheets.

As shown in FIGS. 1A and 1B, in the laminated iron core 10, the plural iron core pieces 11, 12 are joined by two sets of paired caulking protrusions 15 and caulking protrusions 16, but joining by any one or two or more of a resin (a thermosetting resin (for example, an epoxy resin) or a thermoplastic resin), an adhesive and welding can further be added to joining by the caulking protrusions 15, 16.

In addition, the iron core piece 11 is arranged in one end (here, one piece of the lower end, lowermost piece) of the laminated iron core 10 in a lamination direction and is formed with caulking through holes 17, 18, and the other iron core pieces 12 excluding the one end in the lamination direction are formed with the caulking protrusions 15, 16 described above.

In the caulking protrusions 15, 16, the proximal end (one end) continues with a flat part the iron core piece 12, and the other portions, that is, both side parts and the distal end (the other end) are separated from the flat part of the iron core pieces 12 to be inclined in the lamination direction (so-called cantilevered caulking). As a result, the iron core piece 12 is formed with an opening 19 due to the formation of the caulking protrusion 15, and is formed with an opening 20 due to the formation of the caulking protrusion 16.

A shape of each of the caulking protrusions 15, 16 has the same shape and is formed in a rectangular shape in plan view, and specifically, a shape of the proximal end is formed in a rectangular shape in plan view and a shape of the distal end is formed in a circularly arcuate shape in plan view. In addition, the shape of the distal end can be formed in the rectangular shape in plan view. Also, the shapes of the paired caulking protrusions can be formed in different shapes.

The iron core piece 12 is formed with each of the caulking protrusions 15, 16 whose longitudinal direction is orthogonal to a width direction of the iron core piece 12. Here, the orthogonal direction may include, in addition to 90°, directions inclined in the range of ±10° (preferably, ±5°) relative to 90°.

A length w1 of each of the caulking protrusions 15, 16 in a longitudinal direction can be set in the range of, for example, about 0.5 to 2 mm (preferably, a lower limit is 1.0 mm and an upper limit is 1.5 min) and also, a width w2 in a direction orthogonal to this longitudinal direction can be set in the range of, for example, about 0.2 to 1 mm (preferably, 0.7 mm or less), respectively, but can be changed variously according to a kind of electric motor manufactured. In addition, the width w2 of each of the caulking protrusions 15, 16 is, for example, about 20 to 50% (preferably, 40% or less) of the width W of the iron core piece 12 in a formation position of each of the caulking protrusions 15, 16.

The paired caulking protrusions 15 and caulking protrusions 16 are opposed and separate so as to have a distance S in plan view, and are further formed such that the distal ends of the paired caulking protrusions face toward each other (or the proximal ends of the paired caulking protrusions face in opposite directions).

In addition, the case of using the two sets of the paired caulking protrusions 15, 16 is described herein, but one set or plural (three or more) sets of the paired caulking protrusions can be used according to a kind of electric motor manufactured.

Accordingly, a synergistic effect (competitive effect) of the paired caulking protrusions 15, 16 can be obtained, and the plural iron core pieces 12 can be tightly joined without inclination.

In addition, the paired caulking protrusions 15, 16 are arranged so that straight lines passing through the respective longitudinal directions are positioned in the same line in order to obtain the action and effect described above. However, the straight lines passing through the respective longitudinal directions may deviate from the same straight line in the range capable of obtaining the action and effect described above (for example, when the straight lines are parallel or intersect).

Also, the distance S between the paired caulking protrusions 15, 16 can be set in the range capable of obtaining the action and effect described above, for example, the range of about 2 to 10 mm, but can also be set variously according to a kind of electric motor manufactured.

Accordingly, in each of the iron core pieces 12, the other portion including the distal end of the caulking protrusion 15 is separated from the flat part of the iron core piece 12 to be inclined in the lamination direction, and the other portion including the distal end of the caulking protrusion 15 separated from the flat part of the iron core piece 12 (here, the iron core piece 12 of the upper side) adjacent in the lamination direction to be inclined is fitted into the formed opening 19. Also, the other portion including the distal end of the caulking protrusion 16 is separated from the flat part of the iron core piece 12 to be inclined in the lamination dire on, and the other portion including the distal end of the caulking protrusion 16 separated from the flat part of the iron core piece 12 adjacent in the lamination direction to be inclined is fitted into the formed opening 20.

Accordingly, the plural iron core pieces 12 are joined.

At this time, a depth of depressing the distal end of the caulking protrusion 15 to the opening 19 is set at a thickness similar to a plate thickness t (about one time the plate thickness t) of the iron core piece 12 as shown in FIG. 1B, with the result that a tip of the distal end of the caulking protrusion 15 abuts on an inner peripheral surface 21 of the opening 19 of the adjacent iron core piece 12. The same applies to the caulking protrusion 16.

Consequently, in the plural iron core pieces 12 laminated, the iron core piece 12 can be inhibited from deviating in a radial direction.

Also, the other portions including the distal ends of the caulking protrusions 15, 16 separated from the iron core pieces 12 to be inclined are respectively fitted into the caulking through holes 17, 18 formed in the iron core piece 11 and thereby, the iron core piece 11 located in one end in the lamination direction is joined to the iron core piece 12 abutting on this iron core piece 11.

In addition, joining of the iron core pieces constructing the laminated iron core is not limited to the mode described above, and can be implemented by, for example, the following mode. In addition, detailed description is omitted by assigning the same numerals to the same members.

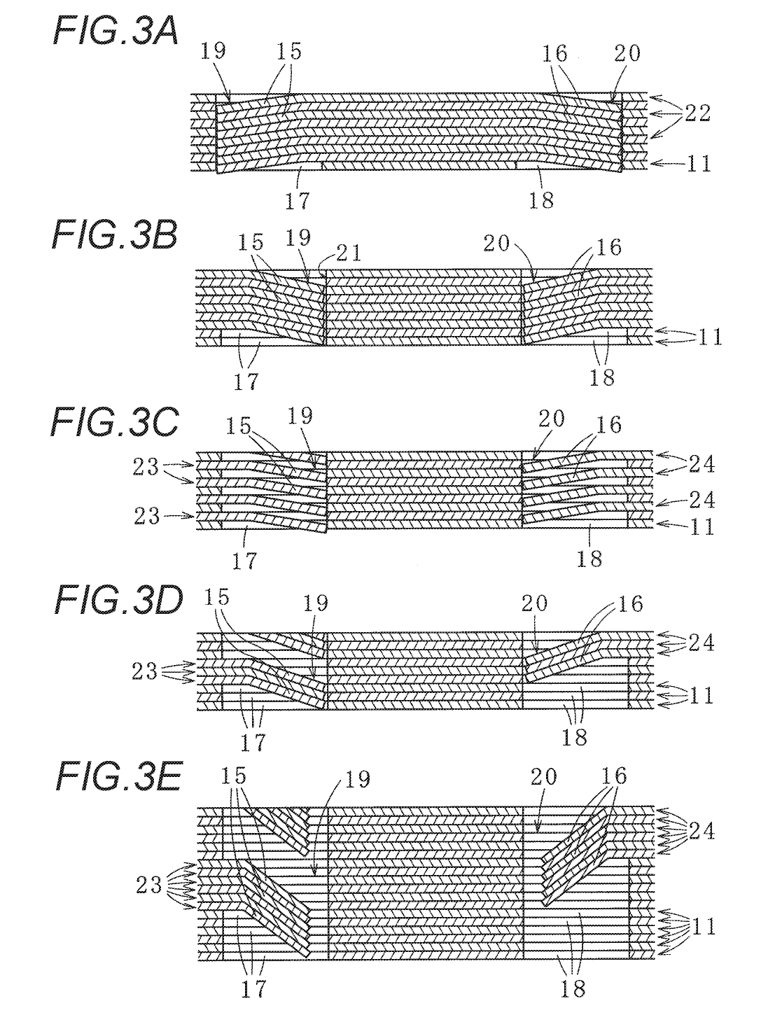

Paired caulking protrusions 15, 16 shown in FIG. 3A are opposed and separate so as to have the distance S in plan view, and are further formed such that the distal ends of the caulking protrusions 15, 16 face in the opposite direction (or the proximal ends of the caulking protrusions 15, 16 face toward each other) (that is, the direction is opposite to the direction of the caulking protrusions 15, 16 shown in FIG. 1B).

Accordingly, a synergistic effect of the paired caulking protrusions 15, 16 can be obtained, and plural iron core pieces 22 can be tightly joined without inclination.

In paired caulking protrusions 15, 16 shown in FIG. 3B, depths of depressing the other portions including the distal ends of the caulking protrusions 15, 16 to the openings 19, 20 are set at about two times the plate thickness t of the iron core piece 12 in FIG. 1B. As a result, the number of iron core pieces 11 arranged in one end of the laminated iron core in the lamination direction is set at two (corresponding to the depressing depth).

In this case, a tip of the distal end of the caulking protrusion 15 does not abut on the inner peripheral surface 21 of the opening 19 of the adjacent iron core piece 12 (the same applies to the caulking protrusion 16). As a result, a joining strength of the plural iron core pieces 12 is slightly lower than that of the case of the paired caulking protrusions 15, 16 shown in FIGS. 1A and 1B, but has no problem.

In paired caulking protrusions 15, 16 shown in FIG. 3C, one iron core piece 23 of the iron core pieces 23, 24 alternately laminated is formed with the caulking protrusion 15 and the other iron core piece 24 is formed with the caulking protrusion 16. In addition, one iron core piece 23 is formed with an opening 20 into which the caulking protrusion 16 is fitted, and the other iron core piece 24 is formed with an opening 19 into which the caulking protrusion 15 is fitted.

In FIG. 3D, the iron core pieces 23 and the iron core pieces 24 shown in FIG. 3C using three pieces as one set are alternately laminated, respectively, and also in FIG. 3E, the iron core pieces 23 and the iron core pieces 24 shown in FIG. 3C using six pieces as one set are alternately laminated, respectively. As a result, in FIGS. 3D and 3E, the numbers of iron core pieces 11 arranged in one end of the laminated iron core in the lamination direction are set at three and six, respectively.

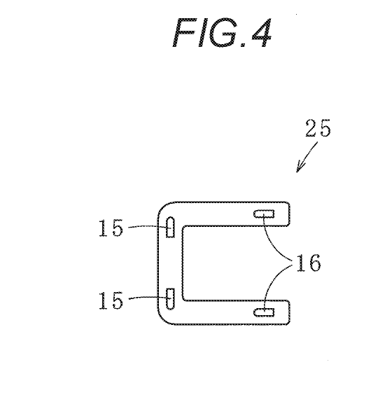

In a laminated iron core 25 shown in FIG. 4, formation positions of the two caulking protrusions 15 shown in FIG. 1A are changed and these caulking protrusions are used as one set of the paired caulking protrusions 15, 15 (direction in which the distal ends of the caulking protrusions 15, 15 face in opposite directions (direction in which the proximal ends of the caulking protrusions 15, 15 face toward each other)).

As long as a joining strength necessary for the laminated iron core can be obtained, it is unnecessary to use the paired caulking protrusions 15, 15 as one set and pair the other caulking protrusions as described above.

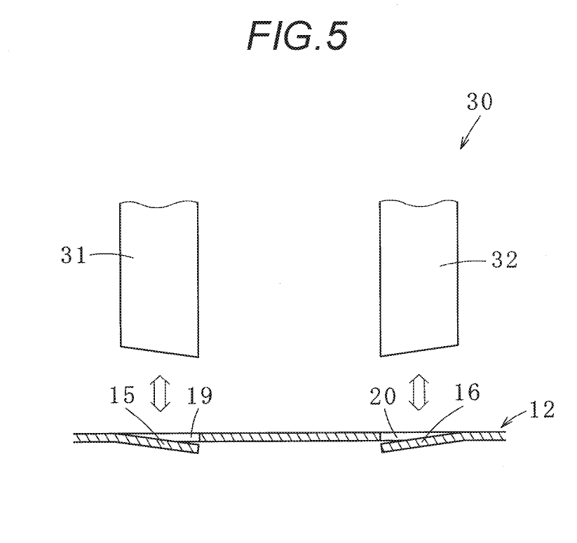

Subsequently, a punch 30 for caulking formation used in a method for manufacturing the laminated iron core according to one embodiment of the present invention will be described with reference to FIGS. 2 and 5.

In the punch 30 for caulking formation, paired punch parts 31, 32 for punching the thin metal sheet 14 to form the caulking protrusions 15, 16 symmetrically. Each of the punch parts 31, 32 has a bar shape, and its plane cross-sectional shape is the same as that of each of the caulking protrusions 15, 16 in plan view.

In addition, the punch parts 31, 32 having the number of punch parts 31, 32 corresponding to the number of caulking protrusions formed are attached to a die.

Next, the method for manufacturing the laminated iron core according to one embodiment of the present invention will be described with reference to FIGS. 1A to 3E.

The method for manufacturing the laminated iron core is a method for blanking the plural iron core pieces 11, 12 from the thin metal sheet 14 with a thickness of 0.2 mm or less using a the (not shown) and laminating the iron core pieces 11, 12 and forming the laminated iron core. The method has a step of forming a pilot hole and an internal shape, a step of forming a caulking through hole, a step of forming a caulking protrusion, a step of forming an external shape, and a laminating step. In addition, formation of the internal shape and the external shape results in a blanking step. Also, the die is respectively arranged in each of the steps, and predetermined blanking and caulking lamination are performed.

Hereinafter, description will be made in detail.

(Step of Forming Pilot Hole and Internal Shape)

A pilot hole 40 and an internal shape 41 are blanked from the thin metal sheet 14.

Accordingly, inside contours of the formed iron core pieces 11, 12 are formed.

(Step of Forming Caulking Through Hole)

The caulking through holes 17, 18 are blanked in a region in which the iron core piece 11 of the thin metal sheet 14 is formed.

In addition, a region in which the iron core pieces 12 of the thin metal sheet 14 are formed is not blanked.

(Step of Forming Caulking Protrusion)

The region in which the iron core pieces 12 of the thin metal sheet 14 are formed is formed with the caulking protrusions 15, 16 in which the proximal end continues with the thin metal sheet 14 and the other portion including the distal end is separated from the thin metal sheet 14.

Here, using the punch 30 for caulking formation, the paired caulking protrusions 15, 16 are opposed and separate so as to have a distance in plan view, and are formed such that the distal ends of the paired caulking protrusions 15, 16 face toward each other (or the proximal ends of the paired caulking protrusions face in opposite directions in FIG. 3A).

(Step of Forming External Shape)

An external shape 42 is blanked in the region in which each of the iron core pieces 11, 12 of the thin metal sheet 14 is formed.

Accordingly, outside contours of the formed iron core pieces 11, 12 are formed.

(Laminating Step)

The plural iron core pieces 12 are sequentially caulked and laminated on the iron core piece 11 formed with the caulking through holes 17, 18.

At this time, the other portion including the distal end of the caulking protrusion 15 formed on the iron core piece 12 is pressed to thereby fit this other portion into the opening 19 or the caulking through hole 17 (in the lowermost layer) of the iron core piece 12 adjacent in the lamination direction formed by the caulking protrusion 15 (the same applies to the caulking protrusion 16).

Accordingly, the adjacent iron core pieces 11, 12 and the iron core pieces 12, 12 are mutually joined to obtain the laminated iron core 10.

By using the laminated iron core, the method for manufacturing the laminated iron core and the punch for caulking formation used in the method for manufacturing the laminated iron core of the present invention as described above, tight caulking lamination is enabled even using the thin plate material with the thickness of 0.2 mm or less.

In addition, the step of forming the internal shape may be performed in the step of forming the external shape, and the step of forming the pilot hole shape may be performed in the step of forming the caulking through hole. Accordingly, the manufacturing steps can be reduced.

The present invention has been described above with reference to the embodiment, but the present invention is not limited to the configuration described in the embodiment described above, and also includes other embodiments and modified examples contemplated within the scope of the matter described in the claims. For example, the case of constructing the laminated iron core, the method for manufacturing the laminated iron core and the punch for caulking formation used in the method for manufacturing the laminated iron core of the present invention by combining a part or all of the respective embodiments and modified examples described above is also included in the scope of right of the present invention.

For example, in the embodiment described above, the thickness of the thin metal sheet is set at 0.2 mm or less, but an effect of the present invention becomes more remarkable by setting the thickness at 0.15 mm or less, further 0.10 mm or less. In addition, a lower limit value of the thickness is not particularly limited, but is about 0.05 mm actually.

### REFERENCE SIGNS LIST

10: LAMINATED IRON CORE
11, 12: IRON CORE PIECE
13: OPENING PORTION
14: THIN METAL SHEET (THIN PLATE MATERIAL)
15, 16: CAULKING PROTRUSION
17, 18: CAULKING THROUGH HOLE
19, 20: OPENING
21: INNER PERIPHERAL SURFACE
22 to 24: IRON CORE PIECE
25: LAMINATED IRON CORE
30: PUNCH FOR CAULKING FORMATION
31, 32: PUNCH PART
40: PILOT HOLE
41: INTERNAL SHAPE
42: EXTERNAL SHAPE

What is claimed is:

1. A laminated iron core comprising:
a plurality of iron core pieces laminated each other, each iron core piece laving a thickness of 0.2 mm or less, wherein
each of the plurality of iron core pieces includes a flat part, openings and a pair of caulking protrusions opposed and separated from each other in plan view, each caulking protrusion having one end continuing with the flat part and the other portion being separated from the flat part to be inclined in a lamination direction of the iron core pieces,
the pair of caulking protrusions of each iron core piece are fitted into the openings formed in an adjacent one of the plurality of iron core pieces in the lamination direction to join the plurality of iron core pieces, and
the other ends of the pair of caulking protrusions face toward each other or face in opposite directions.

2. The laminated iron core according to claim 1, wherein the openings of the iron core piece is formed at an area of the pair of caulking protrusions due to separation of the other portion from the flat part.

3. The laminated iron core according to claim 1, further comprising:
another iron core piece at least disposed at a lowermost layer of the laminated iron core and including caulking through holes into which the pair of caulking protrusions of adjacent one of the plurality of iron core pieces in the lamination direction are fitted.

4. The laminated iron core according to claim 1, wherein a shape of the other end of the caulking protrusion is a circularly arcuate shape in plan view.

5. The laminated iron core according to claim 1, wherein a tip of the other end of the caulking protrusion abuts on an inner peripheral surface of the opening of the adjacent iron core piece.

6. The laminated iron core according to claim 1, wherein the iron core piece is formed in a U shape in plan view, and a width of the iron core piece in a formation position of the caulking protrusion is in a range from 5 mm to 30 mm, both inclusive.

7. A method for manufacturing a laminated iron core by blanking a plurality of iron core pieces from a thin plate material with a thickness of 0.2 mm or less and laminating the iron core pieces thus blanked, the method comprising:
punching the thin plate material to form a pair of caulking protrusions, each having one end continuing with the thin plate material and the other portion being separated from the thin plate material;
blanking a contour of the iron core piece from the thin plate material; and
fitting the pair of caulking protrusion of each iron core piece into openings of an adjacent one of the plurality of iron core pieces in a lamination direction of the iron core pieces to join the plurality of iron core pieces, wherein
the pair of caulking protrusions are formed to be opposed and separate from each other in plan view, and the other ends of the pair of caulking protrusions face toward each other or face in opposite directions.

8. The method for manufacturing the laminated iron core according to claim 7, wherein the openings of the iron core piece is formed at an area of the pair of caulking protrusions due to separation of the other portion from the thin plate material.

9. The method for manufacturing the laminated iron core according to claim 7, further comprising:
forming another iron core piece at least disposed at a lowermost of the laminated iron core and including caulking through holes into which the pair of caulking protrusions of adjacent one of the plurality of iron core pieces in the lamination direction are fitted.

10. The method for manufacturing the laminated iron core according to claim 7, wherein a shape of the other end of the caulking protrusion is a circularly arcuate shape in plan view.

11. The method for manufacturing the laminated iron core according to claim 7, wherein a tip of the other end of the caulking protrusion is abutted on an inner peripheral surface of the opening of the adjacent iron core piece.

12. The method for manufacturing the laminated iron core according to claim 7, wherein the iron core piece is formed in a U shape in plan view, and a width of the iron core piece in a formation position of the caulking protrusion is in a range from 5 mm to 30 mm, both inclusive.

13. A punch for caulking formation, for punching a thin plate material with a thickness of 0.2 mm or less to form a pair of caulking protrusions, each having one end continuing with the thin plate material and the other portion being separated from the thin plate material to be inclined in a lamination direction in order to caulk and laminate a plurality of iron core pieces blanked from the thin plate material, the punch comprising:
a pair of punch parts provided symmetrically, the punch parts forming the pair of caulking protrusions to be opposed and separate from each other in plan view such that the other ends of the pair of caulking protrusions face toward each other or face in opposite directions.
